(19) United States
(12) Patent Application Publication
(10) Pub. No.: US 2011/0127288 A1
(43) Pub. Date: Jun. 2, 2011

(54) PRODUCT VENDING MACHINE

(76) Inventor: Gabriele Valota, Dalmine (IT)

(21) Appl. No.: 12/992,758

(22) PCT Filed: May 13, 2009
(86) PCT No.: PCT/IB2009/005575

§ 371 Date: Feb. 10, 2011

(30) Foreign Application Priority Data
May 14, 2008 (IT) TO2008A 000360

(51) Int. Cl. G07F 11/58

(52) U.S. Cl. 221/247

(57) ABSTRACT

A product vending machine, wherein products are arranged on at least one tray, and are fed by a conveyor device to a release outlet controlled by a release device for allowing only one product at a time to be fed off the tray by the conveyor device; the release device having a retainer, and being movable between a closed position, in which the release device holds the products on the tray and the retainer blocks the outlet at least partly, and an open release position, in which the retainer extends in front of the outlet and at least partly outwards of the tray to intercept the released product and control, in a given manner, the way in which the product drops off the tray.

### CROSS-REFERENCE TO RELATED APPLICATIONS

This application is a U.S. Nationalization of PCT International Application No. PCT/IB2009/005575 filed 13 May 2009, entitled “PRODUCT VENDING MACHINE”, which claims priority to Italian Patent Application No. TO2008A000360 filed 14 May 2008, the entireties of both of the foregoing application are incorporated herein by reference.

### TECHNICAL FIELD

Embodiments of the present invention relate to a product vending machine.

### BACKGROUND ART

Product vending machines are known to comprise a cabinet or similar casing defining a compartment, which is closed by a front door and houses a number of fixed superimposed trays supporting respective numbers of products, such as bottles or cans. The trays occupy a rear portion of the compartment, so as to define, between the door and their front ends facing the door, a drop shaft communicating with a pickup compartment normally located in the base of the cabinet.

The products on each tray are normally arranged in lines perpendicular to the door and resting on respective powered conveyor belts, which are each activated selectively, in use, to feed the relative line of products to a relative release device which releases the products one at a time into the vertical drop shaft.

As disclosed, for example, in WO-A-2008/043631 of the same Applicants, the aforementioned release device normally comprises one or more flaps fitted to the tray to rotate between a closed position preventing the products on the belt from dropping off the tray, and an open position in which the flap/s is/are interposed between the first and second product in the line, so as to only allow the first product in the line to be dropped off the tray by the relative conveyor belt.

A common drawback of vending machines of the above type is that, when dropping off the conveyor belt into the drop shaft, the products tend to tilt forwards towards the door and, in the case of the lines along the sides of the tray, towards the lateral walls of the machine, before dropping vertically into the shaft, thus resulting, not only in damage by impact, but, in the worst case scenario, in the products flipping over inside the shaft and becoming jammed between the end of the tray and door, thus preventing release of the product and also impairing release of subsequent products.

### SUMMARY

One or more embodiments of the present invention provide a product vending machine designed to eliminate the above drawback.

According to an embodiment of the present invention, there is provided a product vending machine. The product vending machine includes at least one substantially horizontal tray configured to support products. The at least one substantially horizontal tray including at least one release outlet, a conveying device configured to feed the products to the at least one release outlet, and a release device. The release device is configured to control the at least one release outlet and selectively allow the products conveyed by the conveying device to drop off the at least one substantially horizontal tray. The release device includes a retainer having a thin curved member extending substantially horizontally and positioned with a concavity thereof facing the at least one substantially horizontal tray. The release device is movable between a closed position in which the release device holds the products on the at least one substantially horizontal tray and the retainer blocks the outlet at least partly, and an open release position in which the retainer extends in front of the outlet and at least partly outwards of the at least one substantially horizontal tray to intercept the product and control the manner in which the product drops off the at least one substantially horizontal tray.

### BRIEF DESCRIPTION OF THE DRAWINGS

A number of non-limiting embodiments of the present invention will be described by way of example with reference to the accompanying drawings, in which:

FIG. 1 shows a schematic view in perspective of a preferred embodiment of the vending machine according to the present invention;

FIGS. 2 and 3 show larger-scale views of a detail in FIG. 1 in different operating configurations;

FIG. 4 shows a detail of a variation of the FIG. 1 vending machine.

### DETAILED DESCRIPTION

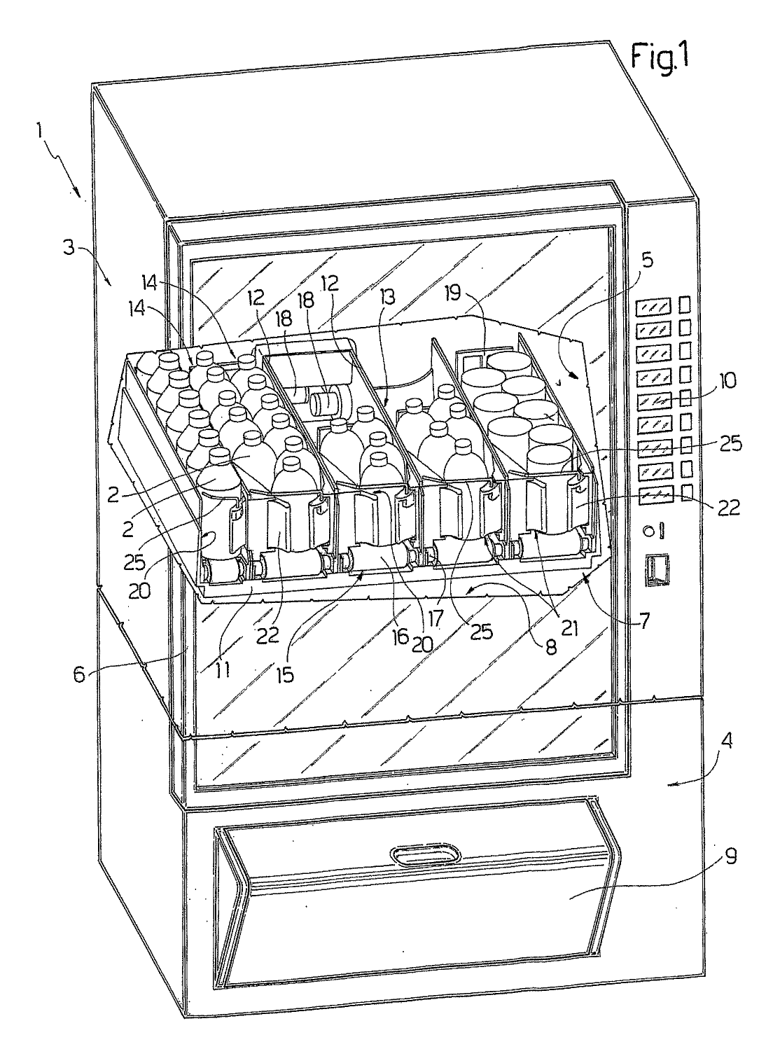

Number 1 in FIG. 1 indicates as a whole a vending machine for products 2, which comprises a cabinet 3 in turn comprising a wall 4 defining the front of an inner compartment 5 and itself defined partly by a door 6 made at least partly of transparent material.

Inside compartment 5, facing door 6, machine 1 houses a number of superimposed trays 7 (only one shown in FIG. 1), which support products 2, extend in respective substantially horizontal planes crosswise to wall 4, and occupy a rear portion of compartment 5, so as to define, between door 6 and their respective front ends facing door 6, a drop shaft 8 communicating with a take-out drawer 9 fitted to wall 4, beneath door 6, and by which to remove from the outside a product 2 selected on a push-button panel 10 on wall 4 and released from one of trays 7 as described below.

With reference to FIG. 1, each tray 7 comprises a frame defined by a substantially horizontal base 11, and by a number of partitions 12 perpendicular to base 11 and to wall 4, and which divide tray 7 into five channels 13 extending perpendicular to wall 4 and housing products 2—in the example shown, bottles and cans—in lines 14 perpendicular to wall 4.

Depending on how wide they are, channels 13 each house one line 14 (in which case, channel 13 is referred to hereinafter as a “one-line” channel), or, to increase the capacity of tray 7, two parallel or offset lines 14 (in which case, channel 13 is referred to hereinafter as a “two-line” channel).

The bottom wall of each channel 13 is defined by a respective belt conveyor 15 comprising a belt 16 looped about two rollers 17 (only one shown in FIG. 1), which are located at the ends of relative channel 13, extend crosswise to partitions 12, and define, on belt 16, a top branch for supporting and conveying relative products 2.

Conveyors 15 of each tray 7 are powered by two electric motors 18 located at the rear end of relative tray 7 and connected to a central control unit (not shown).

More specifically, one of the two motors 18 of each tray 7 powers three of the five conveyors 15, and the other motor 18 powers the other two conveyors 15. Other embodiments, not shown, may obviously comprise more than two motors 18, and each conveyor 15 may even be equipped with its own motor 18. Similarly, in other embodiments not shown, each tray 7 may differ from the tray 7 in the example shown, as regards both the number and width of channels 13.

Each channel 13 has a known support 19 at the rear of relative line 14 to prevent products 2 from toppling over as relative belt 16 moves forward, or in the event of violent shaking of machine 1, e.g. by vandals.

At the end facing door 6, each channel 13 communicates with drop shaft 8 through an opening 20 defined by the free ends of partitions 12 defining channel 13, and which is controlled by a respective release device 21 for selectively releasing products 2 and which, in use, is activated, upon operation of relative conveyor 15, to only allow one product 2 at a time to drop into drop shaft 8.

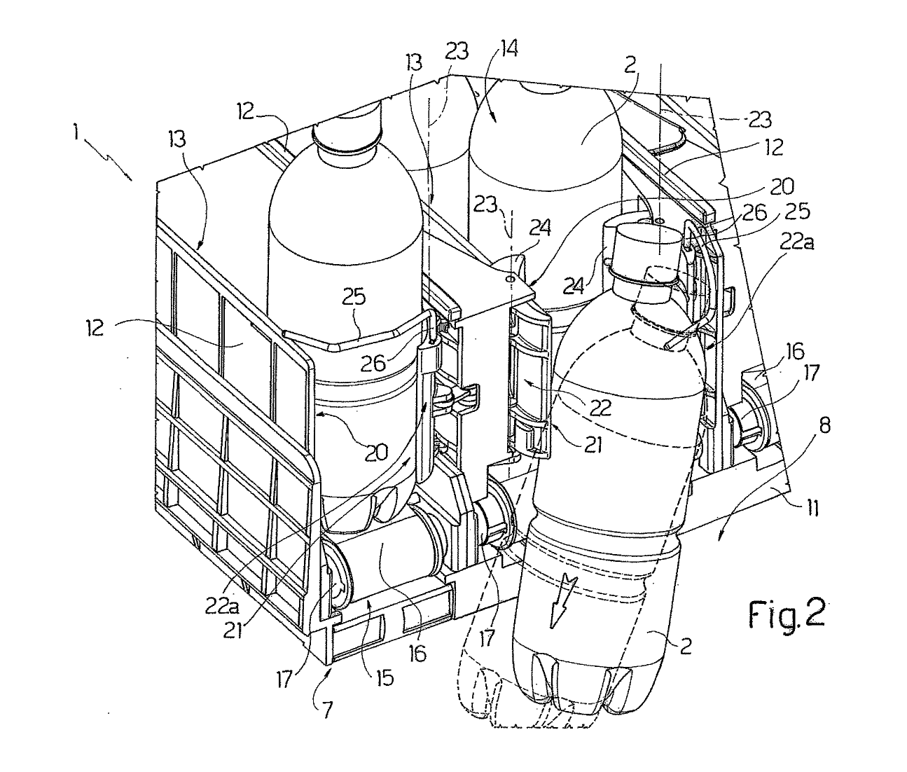

As shown in FIGS. 1 and 2, close to relative opening 20, partitions 12 of each two-line channel 13 have respective thickened portions defining, in channel 13, a funnel tapering towards opening 20 to reduce the two lines 14 to one line and so feed one product 2 at a time to opening 20.

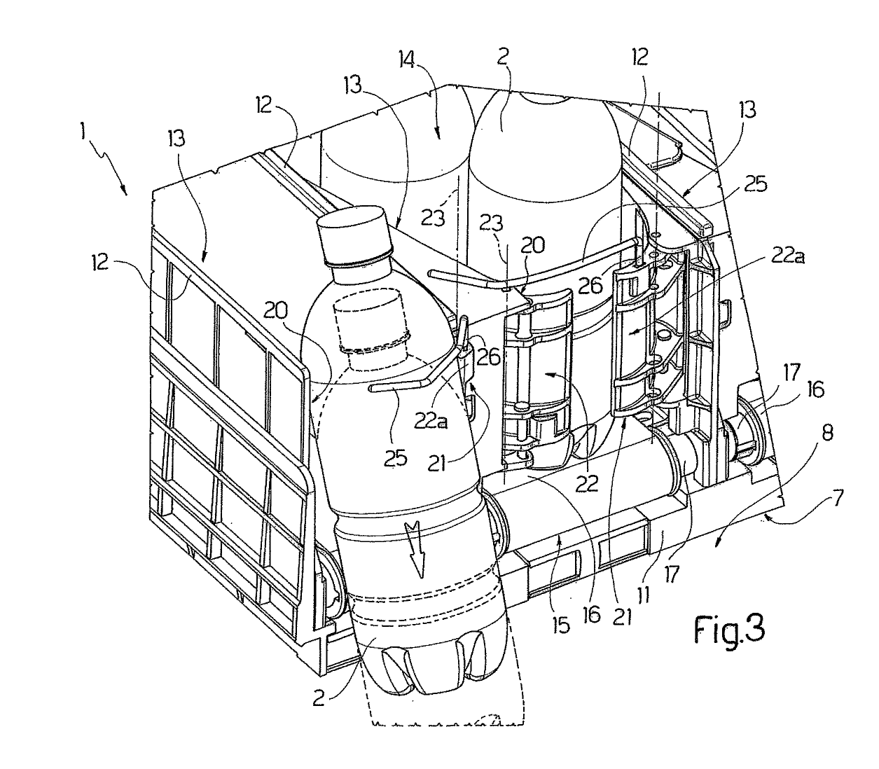

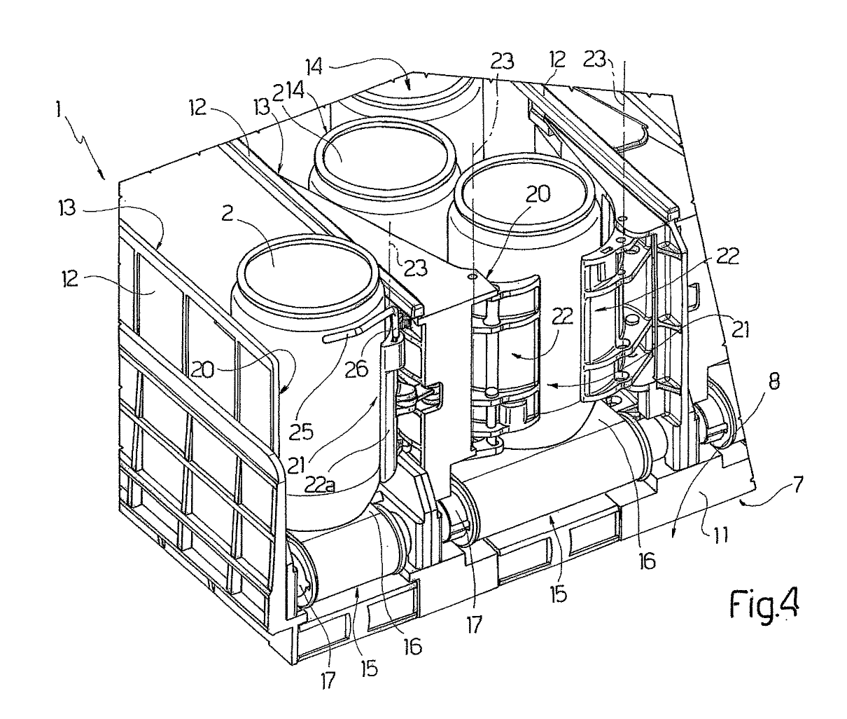

As shown in FIGS. 2 to 4, release devices 21 of two-line channels 13 each comprise two flaps 22, each of which is defined by a curved member positioned with its concavity facing inwards of relative channel 13, and hinged centrally to a respective partition 12 to rotate, about a respective axis 23 perpendicular to base 11, between a closed position (FIGS. 3 and 4), in which flaps 22 partly close opening 20 to hold back products 2 on belt 16, and an open position (FIG. 2), in which flaps 22 allow the first product 2 through opening 20, and hold back the rest of line 14 by means of respective rear portions 24 extending towards the centre of channel 13.

Release device 21 of the one-line channel 13, on the other hand, comprises only one flap 22 identical to flaps 22 of two-line channels 13 and hinged to the partition 12 separating the channel from the adjacent channel 13, to rotate, about a respective axis 23 perpendicular to base 11, between a closed position (FIGS. 2 and 4), in which flap 22 partly closes opening 20 to hold back products 2 on belt 16, and an open position (FIG. 3), in which flap 22 allows the first product 2 in line 14 through opening 20, and holds back the rest of line 14 by means of a rear portion 24 extending towards the centre of channel 13.

Flaps 22 of release devices 21 are operated by respective known actuating devices (not shown) connected to the central control unit (not shown).

As shown in FIGS. 1 to 3, each release device 21 comprises a retainer 25 defined by a thin curved member, which extends substantially horizontally across relative opening 20, is positioned with its concavity facing inwards of channel 13, and serves to govern the fall direction of product 2 released into drop shaft 8, as well as to prevent, in the event of violent shaking of machine 1, e.g. by vandals, products 2 in relative channel 13 from toppling over, and, in the case of the one-line channel, from falling out of channel 13 through the gap between flap 22 and the partition 12 defining the side of tray 7.

Retainer 25 of each two-line channel 13 is located above flaps 22, extends crosswise to relative axis 23, and is connected rigidly to one of flaps 22 (hereinafter referred to for clarity as flap 22a) by a respective appendix 26 projecting downwards from one end of retainer 25 and engaging a hole formed axially in a front portion of flap 22a. Being connected rigidly to flap 22a, retainer 25 is moved, in use, by flap 22a between an inner position (FIG. 3) corresponding to the closed position of flap 22a and in which retainer 25 extends up to the partition 12 facing flap 22a to close opening 20, and an outer position (FIG. 2) corresponding to the open position of flap 22a and in which retainer 25 extends in front of opening 20 and partly across drop shaft 8.

As described above for the two-line channels 13, retainer 25 of one-line channel 13 is located above the single flap 22, extends crosswise to relative axis 23, and is connected rigidly to flap 22 (hereinafter referred to for clarity as flap 22a) so as to be moved by flap 22a between an inner position (FIG. 2) and an outer position (FIG. 3). Structurally, retainer 25 of one-line channel 13 is characterized by curving more sharply than retainers 25 of two-line channels 13.

This difference is due to the difference in the way the one-line and two-line channel retainers 25 control the drop direction of released products 2. That is, in the case of two-line channels 13, product 2, as it is released into drop shaft 8, tends to tilt forwards, while remaining substantially centred with respect to belt 16 by being retained laterally by the two flaps 22, so retainer 25 is more widely curved to enable it to effectively act on product 2 as it drops (FIG. 2) and prevent it from impacting door 6 and, in the worst case scenario, toppling over between tray 7 and door 6.

In the case of one-line channel 13, on the other hand, product 2, as it is released into drop shaft 8, tends not only to tilt forwards but also laterally on the opposite side to flap 22a. The sharper curvature of retainer 25, in this case, prevents product 2, as it is released from channel 13, from tilting either forwards or laterally, and ensures it slides practically vertically downwards (FIG. 3), thus preventing it from impacting door 6 and possibly also the lateral wall of machine 1 adjacent to one-line channel 13.

The function of diverting products 2 as they are released is obviously particularly important when channels 13 are filled with relatively tall products 2, such as bottles or slim cans, which have a tendency to jam easily between tray 7 and door 6 as they are released from channel 13.

In the case of relatively short products 2 and/or products with a very narrow or contoured cross section, on the other hand, the main function of retainer 25 is to prevent products 2 from toppling over and, particularly in the case of one-line channel 13, from falling out of channel 13 in the event of violent shaking of machine 1.

In this case, machine 1 may be modified as shown in the FIG. 4 variation, in which only the one-line channel 13 has retainer 25. In this type of channel, in fact, the risk of product fallout is normally high, on account of the passage between flap 22a and partition 12 facing flap 22a normally being larger than the passage between the two flaps 22 of a two-line channel 13.

Moreover, since lateral toppling of product 2 need not be controlled in this case, retainer 25 is shorter in length than the retainer 25 described above, and only extends partly across relative opening 20.

In other variations not shown, two-line channels 13 may also be equipped with the shorter retainer 25 as described above.

Generally speaking, depending on the type of product 2 in channel 13, the capacity of channel 13, and the location of channel 13 on tray 7, each channel 13 on tray 7 may be equipped with a retainer 25 selected from those described and best suited to perform the function/s required in each specific case.

1. A product vending machine, comprising:
at least one substantially horizontal tray for supporting products, the at least one substantially horizontal tray having,
at least one release outlet;
conveying means for feeding the products to said at least one release outlet; and
a release device for controlling the at least one release outlet and selectively allowing the products conveyed by the conveying means to drop off the at least one substantially horizontal tray, the release device comprises a retainer in turn comprising a thin curved member extending substantially horizontally and positioned with a concavity thereof facing the at least one substantially horizontal tray, the release device being movable between a closed position in which the release device holds the products on the at least one substantially horizontal tray and the retainer blocks the at least one release outlet at least partly, and an open release position in which the retainer extends in front of the at least one release outlet and at least partly outwards of the at least one substantially horizontal tray to intercept the product and control, in a given manner, the way in which the product drops off the at least one substantially horizontal tray.

2. The vending machine as claimed in claim 1, further comprising a drop shaft located to the front of said at least one release outlet and communicating with the at least one release outlet; in the open release position, the retainer extending in front of the outlet and at least partly across the drop shaft to direct the product released into the drop shaft.

3. The vending machine as claimed in claim 1, wherein the at least one substantially horizontal tray is divided by partitions into a given number of channels, each of which houses at least one line of products, and has a respective at least one release outlet and a respective release device; the conveying means comprising, for each channel, a conveyor belt for supporting and feeding the products to the relative at least one release outlet.

4. The vending machine as claimed in claim 3, wherein each release device comprises at least one flap fitted to one of the partitions defining the relative channel to rotate, about a respective substantially vertical axis, between said closed position and said open position; the retainer being connected rigidly to a top end of the flap, and extending, above the flap, in a direction crosswise to the relative channel and towards the other of the partitions defining the channel.

5. The vending machine as claimed in claim 3, wherein the release device comprises two flaps fitted respectively to the two partitions defining the relative channel to rotate, in opposite directions about respective substantially vertical axes, between said closed position and said open position; the retainer being connected rigidly to a top end of one of the flaps, and extending, above the flap, in a direction crosswise to the relative channel and towards the other flap.

6. A product vending machine, comprising:
at least one substantially horizontal tray configured to support products, the at least one substantially horizontal tray including,
at least one release outlet;
a conveying device configured to feed the products to the at least one release outlet; and
a release device configured to control the at least one release outlet and selectively allow the products conveyed by the conveying device to drop off the at least one substantially horizontal tray, the release device including a retainer having a thin curved member extending substantially horizontally and positioned with a concavity thereof facing the at least one substantially horizontal tray, the release device being movable between a closed position in which the release device holds the products on the at least one substantially horizontal tray and the retainer blocks the outlet at least partly, and an open release position in which the retainer extends in front of the outlet and at least partly outwards of the at least one substantially tray to intercept the product and control the manner in which the product drops off the at least one substantially horizontal tray.
